(19) United States
(12) Patent Application Publication
(10) Pub. No.: US 2012/0057115 A1
(43) Pub. Date: Mar. 8, 2012

(54) LIQUID CRYSTAL DISPLAY DEVICE

(75) Inventors: Noboru KUNIMATSU, Chiba (JP); Chikae Matsui, Mobara (JP); Hidehiro Sonoda, Mobara (JP); Yuko Matsumoto, Onjuku (JP); Yosuke Hyodo, Chiba (JP); Masaki Matsumori, Tokai (JP); Yasushi Tomioka, Mobara (JP); Yasuo Imanishi, Katano (JP)

(73) Assignees: Panasonic Liquid Crystal Display Co., Ltd.; Hitachi Displays, Ltd.

(21) Appl. No.: 13/221,163

(22) Filed: Aug. 30, 2011

(30) Foreign Application Priority Data
Sep. 3, 2010 (JP) 2010-197720

(51) Int. Cl. G02F 1/1337

(52) U.S. Cl. 349/123

(57) ABSTRACT

An IPS liquid crystal display device intended to prevent generation of second image sticking after generation of initial DC image sticking.

An alignment film has a two-layer structure comprising an upper alignment film and a lower alignment film. The upper alignment film is an optical alignment film formed of a polyamide acid ester as a precursor. The lower alignment film has a lower resistance value than the upper alignment film and also has a low photoconductive property. The lower alignment film is formed not using, as a precursor, a polyamide acid using PMDA as the starting material but using, as a precursor, the polyamide acid containing a sulfonic acid group or a carboxylic group, whereby the difference of the resistance between portions undergoing or not undergoing light irradiation in the pixel is decreased and generation of second image sticking can be prevented.

### CLAIM OF PRIORITY

The present application claims priority from Japanese Patent Application JP 2010-197720 filed on Sep. 3, 2010, the content of which is hereby incorporated by reference into this application.

### BACKGROUND OF THE INVENTION

1. Field of the Invention

The present invention relates to a liquid crystal display device. The invention more particularly relates to a liquid crystal display device having a liquid crystal display panel that provides, to an alignment film, alignment controllability under irradiation of light.

2. Description of the Related Art

A liquid crystal display device includes a TFT substrate in which pixel electrodes and thin film transistors (TFT) are formed in a matrix, and a counter substrate opposing the TFT substrate and having color filters, etc. formed at portions associated with positions at which the pixel electrodes of the TFT substrate are provided. The liquid crystal display device also includes liquid crystals put between the TFT substrate and the counter substrate. Then, an image is formed by controlling the transmittance of light due to liquid crystal molecules on every pixel.

Since the liquid crystal display device is flat and light in weight, it has diversified applications in the various fields such as large sized display apparatus, for example, TV sets and cellular phones, DSCs (Digital Still Cameras), etc. By contrast, the view angle characteristic is important in the liquid crystal display device. The view angle characteristics are related to a phenomenon that brightness changes or chromaticity changes when the user observes a screen from the front and from an oblique direction. An IPS (In Plane Switching) system, which operates liquid crystal molecules by an electric field in a horizontal direction, has good view angle characteristics.

A method of alignment treatment, that is, providing alignment control function to the alignment film used in the liquid crystal display device includes a method of rubbing treating as the prior art. In the rubbing alignment, alignment is performed by rubbing the alignment film with a cloth. In contrast, there is an optical alignment method of providing alignment controllability to the alignment film in a contactless manner. Since the IPS system exhibits good performance as a pre-tilt angle is smaller, the optical alignment method is advantageous.

JP-A-2010-072011 describes that a two-layer structure is adopted for the alignment film using, as a precursor, a polyimide formed of a polyamide acid ester excellent in optical alignment property for the layer in contact with a liquid crystal layer, and using, as a precursor, a polyimide formed of a polyamide acid in which the resistance can easily be reduced for the lower layer in order to release electric charges.

Japanese Patent Application No. 2010-032443 describes that a two-layer structure is adopted for the alignment film using, as a precursor, a polyimide formed of a polyamide acid ester excellent in the optical alignment property for the layer in contact with a liquid crystal layer, and using, as a precursor, a polyimide formed of a polyamide acid not decomposed by light, having a high mechanical strength but not having cyclobutane for the lower layer. According to this patent document, since the mechanical strength of the lower alignment film is large, high alignment stability can be maintained in terms of optical alignment.

### SUMMARY OF THE INVENTION

When the liquid crystal display device displays an identical pattern for a long time, a phenomenon that the pattern sticks to a screen occurs. For example, a monochromatic checker flag pattern as shown in FIG. 8 is displayed for about 100 hours. In this case, a white area in the checker flag pattern is at a maximum brightness. Subsequently, when the entire screen is turned to a gray pattern, for example, at 31 grayscales/256 grayscales, the checker flag pattern remains as image sticking. If the change coefficient of brightness for a portion displaying black and a portion displaying white is 1% or more, human's eye can recognize this as image sticking. Such a phenomenon includes image sticking referred to as DC image sticking.

This is because electric charges due to the previous pattern remain in an alignment film or an insulating film even after the image is switched, and the electric charges are eliminated along with time. Accordingly, DC image sticking is eliminated with lapse of time. However, since the presence of DC image sticking degrades the image quality, it is desirable to eliminate DC image sticking early.

In JP-A-2010-072011, the alignment film comprises 2-layers in the IPS system in which a layer of lower resistance is disposed in the lower layer thereby lowering the electric resistance of the entire alignment film and promoting the elimination of electric charges accumulated in the alignment film. JP-A-2010-072011 describes that electric charges can be released more efficiently in this case if the lower layer is provided with photoconductivity. FIG. 9 is a graph showing the effect in which a dotted line B is a graph showing the change of image sticking when the electric resistance of the alignment film is high and a solid line A is a graph showing the change of image sticking when the electric resistance of the lower layer film is low. As shown in FIG. 9, when the lower layer film has a low electric resistance, image sticking is eliminated early.

However, after early elimination of image sticking, a phenomenon that additional image sticking occurs has been found. This is hereinafter referred to as second DC image sticking. FIG. 10 shows the phenomenon. In FIG. 10, image sticking is evaluated for four samples. FIG. 10 evaluates the level of image sticking remaining in the screen when the checker flag pattern shown in FIG. 8 is displayed for 100 hours and then a gray pattern is displayed at 31 grayscales/256 grayscales.

In FIG. 10, the abscissa denotes a time t from switching to a gray pattern after the checker flag pattern is displayed for 100 hours. The ordinate MD shows a change coefficient of brightness in the checker flag pattern in a portion where it was white and in a portion where it was black. In FIG. 10, it is estimated that image sticking is eliminated when the change coefficient of brightness is reduced to about 1% or less. As shown in FIG. 10, the change coefficient of brightness is reduced to about 1% or less and image sticking is eliminated once in about 15 min for all of the four samples.

However, as shown in FIG. 10, a phenomenon that image sticking appears again was generated. The second DC image sticking is generated after 30 min and its intensity increases after about 300 min. Such second DC image sticking is particularly strong at about 240 min to 480 min. It has been found that the second DC image sticking is generated when the display time of the checker flag is about 10 hours or more though it does not reach 100 hours. The subject of the present invention is to cope with generation of such second DC image sticking.

The present invention intends to overcome the subject described above and includes the following specific means. That is, the alignment film for aligning liquid crystals has a two-layer structure comprising an upper layer and a lower layer. The upper layer in contact with liquid crystals is an optical alignment film and formed of a polyamide acid ester as a precursor. The lower layer has an electric resistance lower than that of the upper layer and also has a low photoconductive property. The lower layer is formed without using a polyamide acid having PMDA as a starting material but using a polyamide acid containing a sulfonic acid group or a carboxylic group as a precursor. When the lower layer contains neither the sulfonic acid group nor the carboxylic groups, the thickness of the interlayer insulating film present between the counter electrode and the pixel electrode is defined as 770 nm or more.

According to the invention, since generation of second DC image sticking after forming first DC image sticking can be prevented, a liquid crystal display device of high image quality can be attained.

### BRIEF DESCRIPTION OF THE DRAWINGS

FIG. 1 is a cross sectional view of an IPS liquid crystal display device;

FIG. 2 is a plan view for a pixel in FIG. 1;

FIG. 3 is a perspective view showing the configuration of an alignment film according to the invention;

FIG. 4 shows an equivalent circuit near a pixel;

FIG. 5 is an explanatory view showing a DC brightness moderation time constant;

FIG. 6 shows a production process of a lower alignment film;

FIG. 7 is a table showing the effect of the invention;

FIG. 8 is an inspection pattern for DC image sticking;

FIG. 9 is a graph showing the change of DC image sticking;

FIG. 10 shows an evaluation result of image sticking;

FIG. 11 is a schematic cross sectional view showing a mechanism by which second image sticking is generated; and

FIG. 12 is an equivalent circuit showing a mechanism by which second image sticking is generated.

### DESCRIPTION OF THE PREFERRED EMBODIMENTS

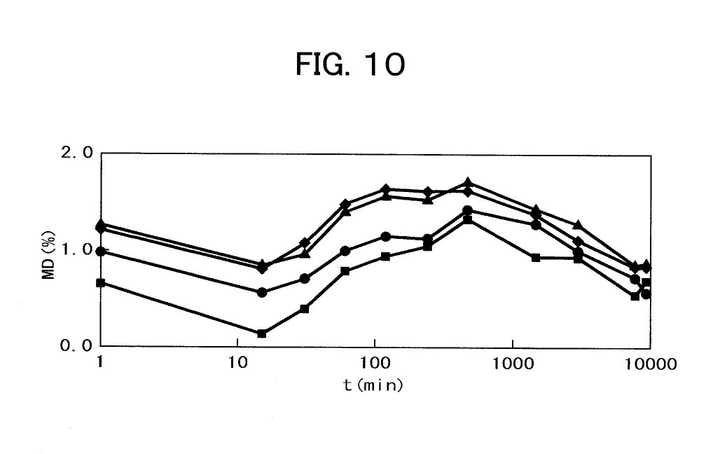

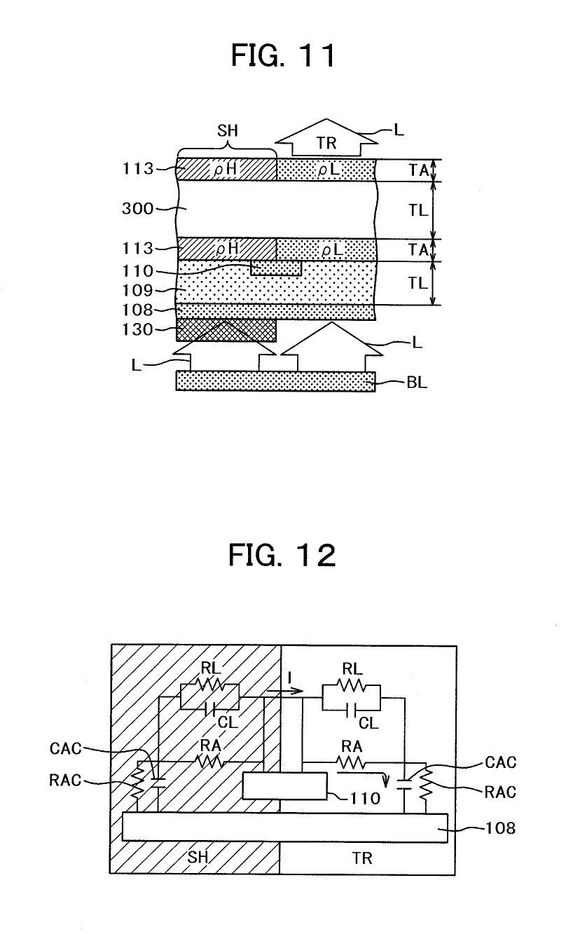

A generation mechanism of second DC image sticking shown in FIG. 10 will be described. FIG. 11 is a schematic cross sectional view of a liquid crystal display device. In FIG. 11, a backlight BL is disposed at the lowermost position. A liquid crystal panel is present above the backlight BL. The liquid crystal panel includes, in a pixel portion, a light shielding film 130, a counter electrode 108, an interlayer insulating film 109, a pixel electrode 110, a lower alignment film 113, a liquid crystal layer 300, and an upper alignment film 113 orderly from below in which other constituent elements of the liquid crystal panel are not illustrated. In FIG. 11, the thickness of the interlayer insulating film 109 is, for example, 500 nm, the thickness TA of the alignment film is, for example, 100 nm, and the thickness TL of the liquid crystal layer is, for example, 4 μm.

In FIG. 11, light L from the backlight BL is irradiated at the back of the liquid crystal panel. The light L from the backlight BL is shielded by the light shielding film 130. The alignment film 113 has a photoconductive property and the resistance is lowered as ρL in a portion where the light L is irradiated from the backlight BL. When the electric resistance of the alignment film 113 is low, electric charges accumulated at the surface are eliminated early and DC image sticking is also eliminated.

On the other hand, the electric resistance of the alignment film 113 remains high as it is at pH in a portion where the light L from the backlight BL does not transmit. Accordingly, it takes much time for elimination of electric charges accumulated in the portion of the alignment film 113. However, since the light shielded portion is a portion not used for forming the image, the portion gives no effect on DC image sticking.

However, it has been found that when electric charges accumulated in the light shielding portion transfer to the backlight transmission portion of the alignment film 113 and a predetermined time lapses, the electric charges again charge the alignment film 113 in the transmission portion, thereby generating second DC image sticking. FIG. 12 is an equivalent circuit showing the state. In FIG. 12, a pixel electrode 110 is formed above a counter electrode 108 by way of an insulating layer 109. The pixel electrode 110 is connected with a counter substrate by way of on alignment film 113 and a liquid crystal layer 300 and further by way of a capacitance. In FIG. 12, the transmission portion TR is on the right side and the light shielding portion SH is on the left side.

In FIG. 12, the liquid crystal layer is represented by a circuit in which a capacitance CL and a resistance RL are connected in parallel, and the alignment film is represented by resistance RA. Capacitance between the alignment film and the counter electrode is CAC and a leak resistance of CAC is RAC. Electric charges accumulated in CAC generates DC image sticking.

Meanwhile, the resistance RA is lowered, for example, to 10¹³ Ωcm due to the photoconductive property in the transmission portion. On the other hand, since the resistance is not lowered by photoconduction in the light shielding portion, the resistance RA is, for example, 10¹⁴ Ωcm. Accordingly, electric charges in the transmission portion are eliminated early through the resistance RAC and image sticking are also eliminated early.

However, the resistance of the alignment film 113 is high in the light shielding portion and electric chares are accumulated in the alignment film for a long time. The electric charges transfer to the transmission portion the alignment film 113 as shown by an arrow to charge the transmission portion of the alignment film again and generate second DC image sticking. Since charges transfer from the light shielding portion to the transmission portion not in the direction of the thickness but in the direction of the plane, the resistance is extremely high and it takes much time for charge transfer, second DC image sticking is generated after elimination of typical DC image sticking.

The invention prevents generation of such second DC image sticking by the invention as shown in the following examples.

### Example 1

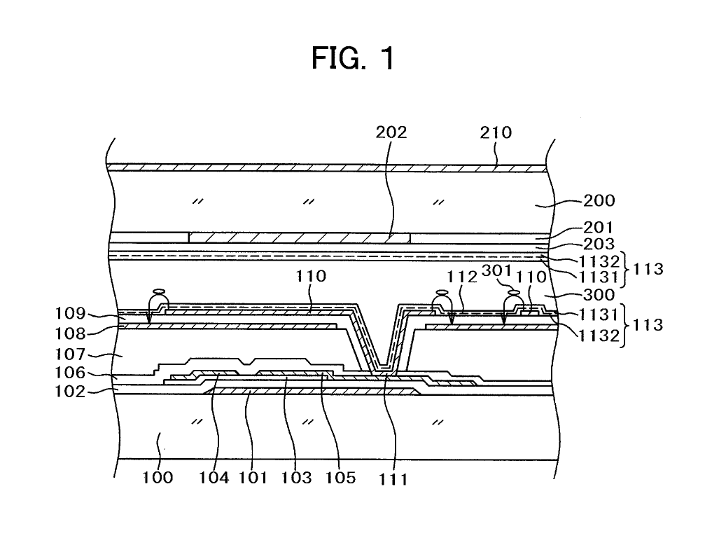

FIG. 1 is a cross sectional view showing a structure in a display region of an IPS liquid crystal display device. The structure shown in FIG. 1 has been used generally at present and, referring briefly, a comb-shaped pixel electrode 110 is formed over a counter electrode 108 in a planar solid form with an insulating film 109 being sandwiched therebetween. Then, an image is formed by rotating liquid crystal molecules 301 by a voltage between the pixel electrode 110 and the counter electrode 108 thereby controlling the transmittance of light on every pixel in the liquid crystal layer 300.

In FIG. 1, a gate electrode 101 is formed on a TFT substrate 100 formed of glass. The gate electrode 101 is formed in a layer identical with that of scanning lines. The gate electrode 101 comprises an MoCr alloy stacked on an AlNd alloy.

A gate insulating film 102 is formed of SiN while covering the gate electrode 101. A semiconductor layer 103 is formed of a-Si film on the gate insulating film 102 at a position opposed to a position where the gate electrode 101 is provided. The a-Si film forms a channel portion of TFT, and a drain electrode 104 and a source electrode 105 are formed on the a-Si film while the channel portion is put therebetween. An n+Si layer (not illustrated) is formed between the a-Si film and the drain electrode 104 or the source electrode 105, for establishing ohmic contact between the semiconductor layer and the drain electrode 104 or the source electrode 105.

The drain electrode 104 is used also as a video signal line and the source electrode 105 is connected with the pixel electrode 110. Both the drain electrode 104 and the source electrode 105 are formed simultaneously in an identical layer. In the example, the drain electrode 104 or the source electrode 105 is formed of an MoCr alloy. When it is intended to lower the electric resistance of the drain electrode 104 or the source electrode 105, an electrode structure in which an AlNd alloy is sandwiched with the MoCr alloy is used.

An inorganic passivation film 106 is formed of SiN and covers the TFT. The inorganic passivation film 106, particularly, protects the channel portion of the TFT from impurities. An organic passivation film 107 is formed over the inorganic passivation film 106. since the organic passivation film 107 also has a function of planarizing the surface of the TFT at the same time with that of protecting the TFT, it is formed at a large thickness. Its thickness is from 1 μm to 4 μm.

A counter electrode 108 is formed on the organic passivation film 107. The counter electrode 108 is formed by sputtering ITO (Indium Tin Oxide) as a transparent conductive film over the entire display region. That is, the counter electrode 108 is formed in a planar shape. After the counter electrode 108 has been formed over the entire surface by sputtering, the counter electrode 108 is removed only for the portion of a through hole 111 for electric conduction between the pixel electrode 110 and the source electrode 105.

An interlayer insulating film 109 is formed of SiN while covering the counter electrode 108. After the interlayer insulating film 109 has been formed, a through hole 111 is formed by etching. The through hole 111 is formed by etching the inorganic passivation film 106 with the interlayer insulating film 109 as a resist. Then, ITO as the pixel electrode 110 is formed by sputtering while covering the interlayer insulating film 109 and the through hole 111. The pixel electrode 110 is formed by pattering the sputtered ITO. ITO as the pixel electrode 110 is deposited also in the through hole 111. In the through hole 111, the source electrode 105 extended from TFT and the pixel electrode 110 are conducted and a video signal is supplied to the pixel electrode 110.

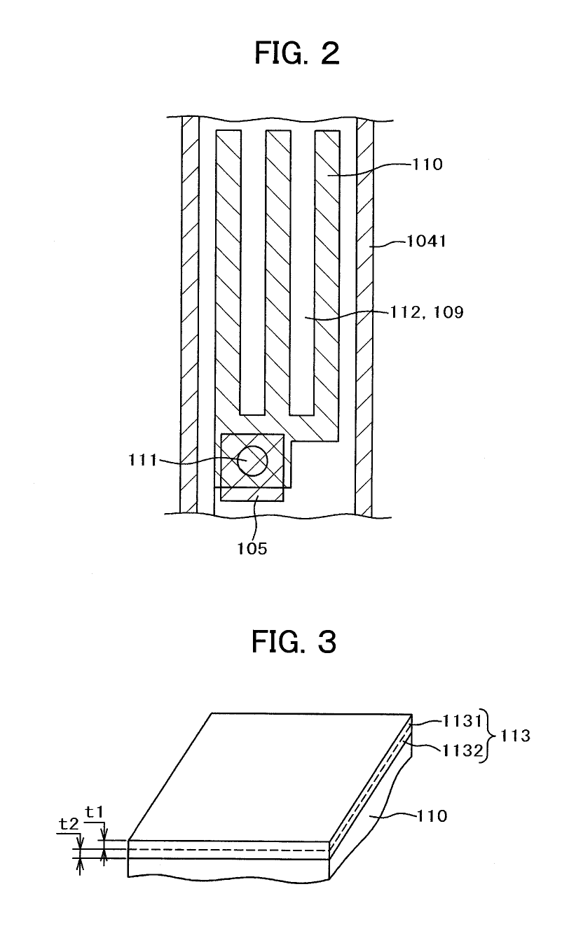

FIG. 2 shows an example of the pixel electrode 110. The pixel electrode 110 is a comb-shaped electrode. Video signal lines 1041 are present on both sides of the pixel electrode 110. A slit 112 is formed between adjacent comb-teeth. Below the pixel electrode 110, a planar counter electrode 108 is formed. When a video signal is applied to the pixel electrode 110, liquid crystal molecules 301 are rotated by lines of electric force generated between the pixel electrode 110 and the counter electrode 118 through the slit 112. Thus, the light passing through the liquid crystal layer 300 is controlled to form an image.

In FIG. 2, the pixel electrode 110 is connected by way of the through hole 111 with the source electrode 105 of the TFT. The source electrode 105 and the pixel electrode 110 overlap each other. Since the source electrode 105 is formed of a metal, the light from the backlight is not irradiated to the alignment film 113 formed above the pixel electrode 110 at the portion where the source electrode 105 and the pixel electrode 110 overlap each other. Since the alignment film 113 has a photoconductive property, the resistance of the alignment film 113 becomes higher at a portion overlapping the source electrode 105 compared with a portion not overlapping therewith.

An alignment film 113 for aligning liquid crystal molecules 301 is formed over the pixel electrode 110. In the invention, the alignment film 113 has a two-layer structure comprising an optical alignment film 1131 in contact with the liquid crystal layer 300 and a low resistance alignment film 1132 formed below the optical alignment 1131. The configuration of the alignment film 113 will be described specifically later.

In FIG. 1, a counter electrode 200 is disposed with a liquid crystal layer 300 sandwiched between the counter electrode 200 and the TFT substrate. A color filter 201 is formed inside of the counter electrode 200. The color filter 201 comprises red, green, and blue color filters 201 on every pixel to form color images. A black matrix 202 is formed between adjacent color filters 201, to improve the contrast of the image. The black matrix 202 functions also as a light shielding film for the TFT and prevents a photocurrent from flowing to the TFT.

An overcoat film 203 is formed while covering the color filter 201 and the black matrix 202. Since the surface of the color filter 201 and the black matrix 202 is uneven, the surface is planarized by the overcoat film 203.

An alignment film 113 for determining initial alignment of liquid crystals is formed on the overcoat film 203. The alignment film 113 on the side of the counter electrode also has a two-layer structure comprising an optical alignment film 1131 in contact with the liquid crystal layer 300 and a low resistance alignment film 1132 formed below the optical alignment film 1131 in the same manner as the alignment film 113 on the side of the TFT substrate. An external conductive film 210 is formed to the outer side of the counter electrode 200 for stabilizing the potential inside the liquid crystal panel, and a predetermined voltage is applied to the external conductive film 210.

FIG. 3 is a schematic view showing an alignment film 113 according to this embodiment. In FIG. 3, the alignment film 113 is formed over a pixel electrode 110 and comprises an upper alignment film 1131 as an optical alignment film 113 and a lower alignment film 1132 having a resistance lower than that of the upper alignment film 1131.

The upper alignment film 1131 comprises a polyimide formed of a polyamide acid ester having excellent optical alignment property as a precursor. Chemical formula (1) shows a structural formula of the polyamide acid ester having excellent optical alignment property.

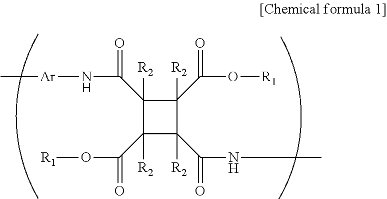

In the chemical formula (1), R₁ each represents independently an alkyl group of 1 to 8 carbon atoms, R₂ each represent independently a hydrogen atom, a fluorine atom, a chlorine atom, a bromine atom, a phenyl group, an alkyl group of 1 to 6 carbon atoms, an alkoxy group of 1 to 6 carbon atoms, a vinyl group (—(CH₂)ₘ—CH═CH₂, m=0, 1, 2), or an acetyl group (—(CH₂)ₘ—C≡CH, m=0, 1, 2), and Ar represents an aromatic compound.

The polyamide acid ester of excellent optical alignment property has a light decomposing site and, when a polyimide formed of the polyamide acid ester as the precursor is irradiated with polarized UV light, the light decomposing site of the polyimide in parallel with the polarizing direction of the UV light is decomposed and the alignment film has a monoaxial anisotropy. The thus formed optical alignment film has a pre-tilt angle of about 0. When the pre-tilt angle at the surface of the alignment film is measured, numerical values of about −0.1 degree to +0.1 degree are shown. However, such an extent of pre-tilt angle may be regarded as 0. For particularly in the IPS system, light control by liquid crystal molecules can be performed effectively if the pre-tilt angle of the alignment film can be reduced to 0.

As described above, while the alignment film 1131 comprising the polyimide formed of the polyamide acid ester as the precursor shows excellent property for optical alignment, it has high electric resistance and it is difficult for early elimination of DC image sticking. Then, in the alignment film according to the invention, a polyimide formed of a polyamide acid as the precursor allowing the electric resistance to decrease is used for the lower alignment film 1132.

The alignment film comprising the polyimide formed of the polyamide acid as the precursor usually has a photoconductive property and the electric resistance thereof is lowered upon light irradiation. Since the photoconductive property can early release the electric charges accumulated to the alignment film, it is advantageous for early elimination of the DC image sticking. However, when the difference of the electric resistance of the alignment film is large between a portion irradiated with light and a portion not irradiated with light due to the effect of the photoconductive property, second DC image sticking is generated as described previously.

Accordingly, to prevent the generation of the second DC image sticking, the lower alignment film 1132 comprising the polyimide formed of the polyamide acid as the precursor preferably has a smaller photoconductive property. That is, while it is preferred that the electric resistance of the lower alignment film 1132 be lower than the electric resistance of the upper alignment film 1131 in the invention, it is also preferred that the photoconductive property of the lower alignment film 1132 per se be also smaller.

The photoconductive property is dependent on the intensity of light irradiated from the backlight, that is, it has brightness dependence. For example, the electric resistance upon light irradiation at a brightness of 10,000 cd/m² is lower than the electric resistance upon light irradiation at a brightness of 1,000 cd/m². In the invention, it is necessary that the ratio between the electric resistance of the alignment film upon light irradiation at 1,000 cd/m² and the electric resistance of the alignment film upon light irradiation at 10,000 cd/m² be at a predetermined value or less.

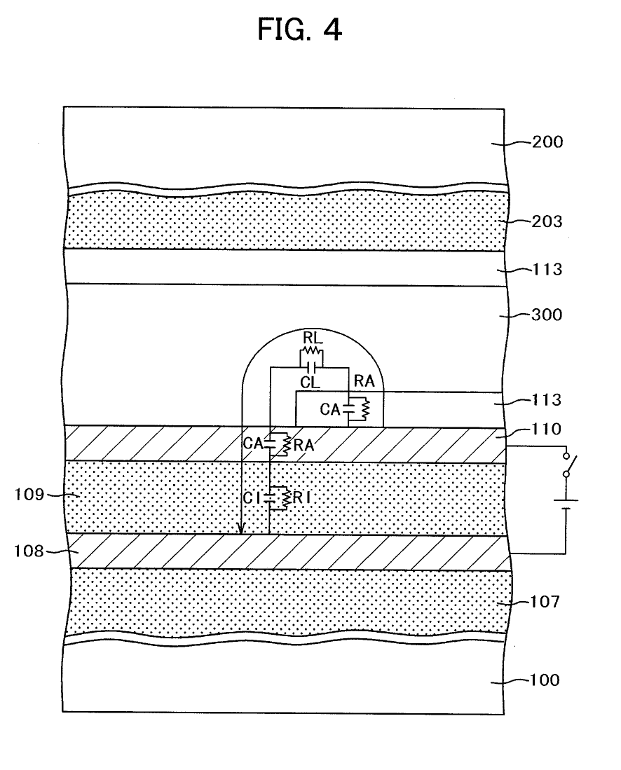

To define the ratio specifically, a parameter of DC brightness moderation time constant is adopted. The DC brightness moderation time constant can be determined, for example, with reference to an equivalent circuit as shown in FIG. 4. FIG. 4 is a fragmentary cross sectional view of the liquid crystal panel shown in FIG. 1. On the side of a TFT substrate 100 in FIG. 4, a counter electrode 108 is formed on an organic passivation layer 107, and a pixel electrode 110 is formed thereabove by way of an interlayer insulating film 109. An alignment film 113 is formed while covering a pixel electrode 110 and an interlayer insulating film 109. Further, an alignment film 113 is formed on the overcoat film 203 in a counter electrode 200, and a liquid crystal layer is present between the alignment films 113, 113.

In FIG. 4, when a switch is turned-on to apply a voltage across the pixel electrode 110 and the counter electrode 108, a line of electric force is generated as shown by an arrow in FIG. 4. The liquid crystal molecules are rotated by the line of electric force and the amount of light passing through the liquid crystal layer 300 is controlled. It can be regarded that an equivalent circuit as shown in FIG. 4 is formed along an electric field extending from the pixel electrode 110 to the counter electrode 108. The equivalent circuit shown in FIG. 4 and an equivalent circuit shown in FIG. 12 are based on different models.

In FIG. 4, it can be considered that electric charges from the pixel electrode 110 transfer through the alignment film 113, the liquid crystal layer 300, and the interlayer insulating film 109 serially and reach the counter electrode 108. Each of the layers comprises a parallel circuit of capacitance and resistance. When a DC voltage is applied on the pixel electrode, the DC voltage is first divided in accordance with the capacitance of each of the layers and is developed on the surface of each of the layers. In this case, the capacitance CL of the liquid crystal is small compared with other capacitance, that is, the capacitance CA of the alignment film and the capacitance CI of the interlayer insulating film. Then, a high voltage is applied to the liquid crystal layer at the instance the DC voltage is applied. Accordingly, when the liquid crystal panel is normally black, the screen becomes bright.

By contrast, since leak resistance is present in each of the layers, as time elapses the potentials on the layers are settled to potentials determined by the leak resistance RA of the alignment film 113, the leak resistance RL of the liquid crystal layer, and the real resistance CI of the interlayer insulating film 109, respectively. That is, the voltage applied to the liquid crystal layer 300 is gradually lowered. Accordingly, when the liquid crystal panel is normally black, the brightness becomes high at the instance the DC voltage is applied, and then the brightness is gradually lowered and approaches a predetermined luminosity.

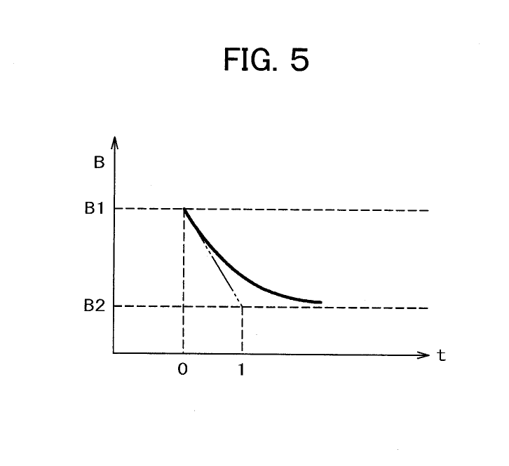

The state is shown in FIG. 5. In FIG. 5, the abscissa represents time t and the ordinate represents brightness of a liquid crystal display device. That is, when the DC voltage is applied between the pixel electrode and the counter electrode at time 0 in FIG. 4, liquid crystal molecules are rotated and the light from the backlight transmits through the liquid crystal layer and increases the brightness of the liquid crystal display device.

As has been explained for the circuit in FIG. 4, since the DC voltage is divided in accordance with the capacitance of each of the elements such as the alignment film 113, the liquid crystal layer 300, and the interlayer insulating film 109 just after the application of the DC voltage, the voltage applied on the liquid crystal is high. Accordingly, the brightness of the liquid crystal display device is high at the instance described above and it is, for example, at B1 in FIG. 5. Then, the voltage applied to each of the elements is gradually settled to a voltage determined by the leak resistance of each of the elements and the brightness is finally settled to B2 shown in FIG. 5. In the transient phenomenon shown in FIG. 5, the time constant when the brightness changes from B1 to B2 is a DC brightness moderation time constant T. That is, when the change of the brightness in FIG. 5 is approximated as discharge of a capacitor, the time constant T is defined as a time when the brightness changes from the initial brightness B1 to a brightness: B2+(B1−B2)×0.368. In this case, 0.368=1/e.

As shown in FIG. 4, the DC brightness moderation time constant T varies depending on the magnitude of the leak resistance of each of the elements. Since the alignment film has photoconductivity, the leak resistance of the alignment film is different and the DC brightness moderation time constant T is also different between a case where the alignment film is irradiated with light that tends to generate photoconductivity and a case where the alignment film is irradiated with light that less tends to generate photoconductivity.

The effect of the photoconductivity is larger in the case of light irradiation at a higher brightness, for example, light irradiation at 10,000 cd/m² than in the case of light irradiation at a lower brightness, for example, light irradiation at 1,000 cd/m². That is, the resistance of the alignment film becomes lower in the case of light irradiation at a higher brightness. That is, the DC brightness moderation time constant T shown in FIG. 5 is larger when light at 1,000 cd/m² is irradiated and it is, for example, T1, whereas it is smaller when light at 10,000 cd/m² is irradiated and it is, for example, T2.

In the invention, it is preferred that the photoconductivity of the alignment film be smaller when a visible light from the backlight is irradiated. The method of evaluating the photoconductivity of the alignment film is an evaluation method based on the ratio between the DC brightness moderation time constant T1 when light at low brightness, for example, 1,000 cd/m² is irradiated and the DC brightness moderation time constant T2 when light at high brightness, for example, at 10,000 cd/m² is irradiated. That is, it can be said the photoconductivity is more remarkable as the difference between T1 and T2 is larger.

From the evaluation of the second DC image sticking based on the finding described above, it has been found that the phenomenon of the second image sticking can be prevented by using an alignment film having T1/T2 ratio of 3 or less, that is, a ratio between the DC brightness moderation time constant T1 when light at a brightness I is irradiated and a DC brightness moderation time constant T2 when light at a brightness I×10 is irradiated.

On the other hand, the second DC image sticking is detected remarkably when usual DC image sticking remains shortly as 30 min or less. The phenomenon is evaluated typically by light at a low brightness. That is, it can be said that the invention is particularly effective when the DC brightness moderation time constant T1 is 30 min or less upon light irradiation at 1,000 cd/m².

In the invention, while the alignment film comprises two layers, evaluation has been described as the entire of the two-layered alignment film. Actually, there is less possibility that the material can be changed greatly for the upper alignment film due to the requirement for the optical alignment property. On the contrary, there is large possibility that the material can be changed greatly for the lower alignment film so as to decrease the second DC image sticking.

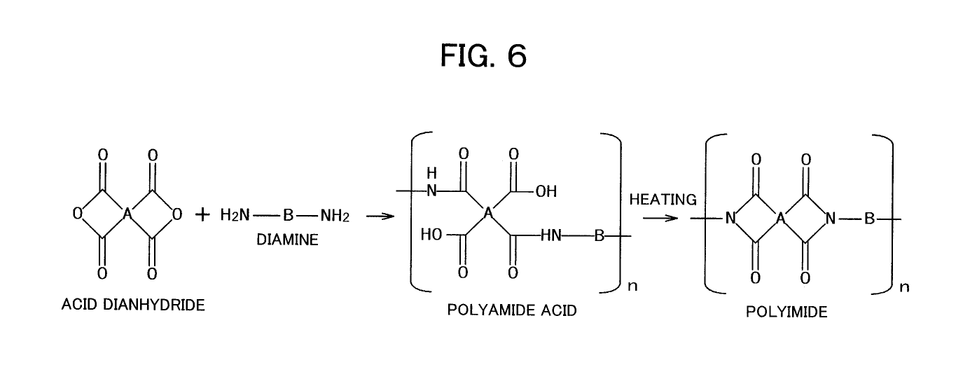

The lower alignment film is an alignment film comprising a polyimide formed of a polyamide acid as a precursor. FIG. 6 is a structural formula showing the formation of the alignment film. As shown in FIG. 6, a polyamide acid is formed by mixing an acid dianhydride and a diamine. The polyamide acid is imidized by heating to form a polyimide, which constitutes the lower alignment film. In the usual heating process, the polyamide acid is not necessarily imidized for 100%; it remains as an unreacted product in a range from 10 to 50% thereof. The upper alignment film 1131 and the lower alignment film 1132 are not necessarily prepared separately. A liquid comprising a mixture of a polyamide acid ester as the precursor of the upper alignment film and a polyamide acid as the precursor of the lower alignment film is coated. Thereafter, the mixture is separated into an upper layer and a lower layer in the subsequent drying (leveling) step, thereby allowing the upper layer 1131 and the lower layer 1132 be simultaneously formed.

In FIG. 6, a portion A in the structure formula of the acid dianhydride is preferably a material represented by the chemical formula (2) or the chemical formula (3).

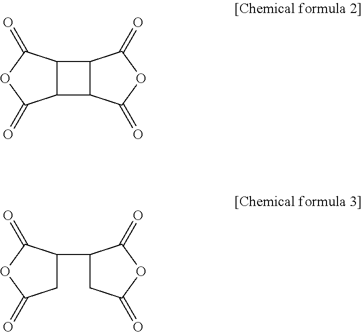

A material in which the portion A of the acid dianhydride is a benzene ring as shown by the chemical formula (4), that is, PMDA (Pyromellitic Dianhydride) has been used so far.

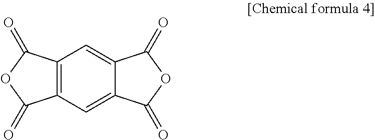

However, when PMDA is used as the acid dianhydride, the photoconductivity of the formed alignment film easily tends to generate second image sticking. Accordingly, a material having the benzene ring for the portion A shown in the structural formula of the acid dianhydride in FIG. 6, that is, PMDA is not used for the lower alignment film of the invention.

The portion B in the diamine shown in FIG. 6 is, for example, a benzene ring and an example of a specific structural formula of the diamine is shown by the chemical formula (5).

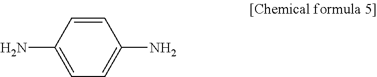

In the invention, a diamine introduced with a sulfonic acid group or a carboxyl group is used as other example of preferred polyamide acid. Such diamine structure is shown in the chemical formula (6), chemical formula (7), chemical formula (8), chemical formula (9), chemical formula (10), and chemical formula (11).

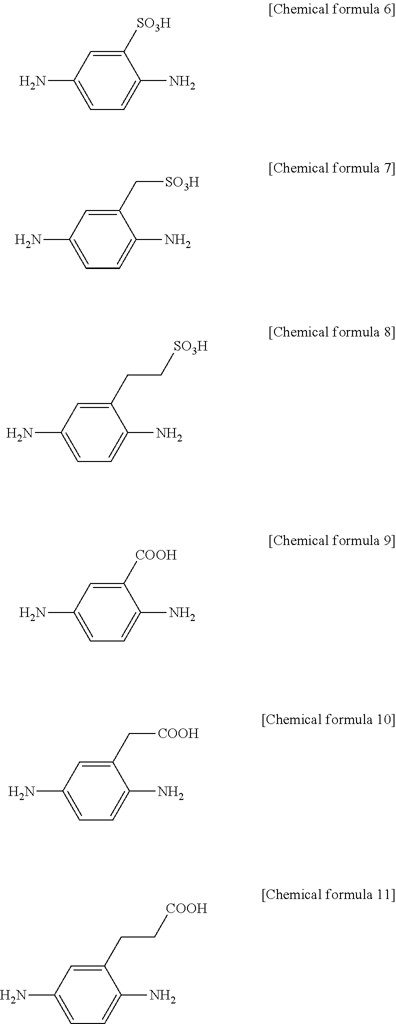

By using the polyamide acid as described above, it is possible to form a lower alignment film having a lower resistivity and a lower photoconductivity than those of the alignment film in the upper layer comprising the polyimide formed of the polyamide acid ester as the precursor.

As has been described with reference to FIG. 12, the second image sticking is generated when electric charges accumulated in the alignment film not undergoing light irradiation from the backlight transfer to the alignment film undergoing light irradiation from the backlight and is lowered in the resistance. The phenomenon undergoes the effect of the thickness of the interlayer insulating film.

As the interlayer insulating film has a large thickness, electric charges accumulated in the alignment film tend to transfer and, as a result, the second image sticking is less generated. While the thickness of the existent interlayer insulating film is about 500 nm, when the thickness of the interlayer insulating film is increased to 770 nm or more, electric charges accumulated in the alignment film transfer easily and thereby the generation of the second image sticking is suppressed.

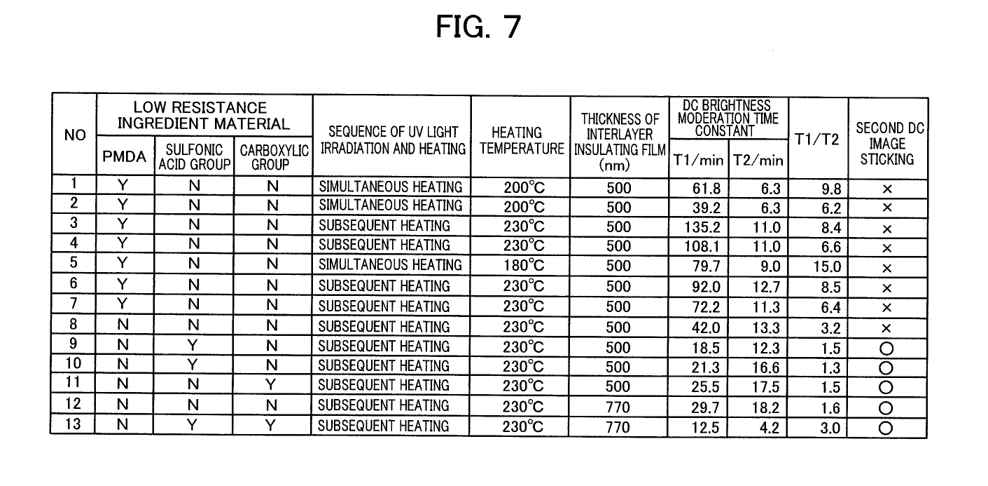

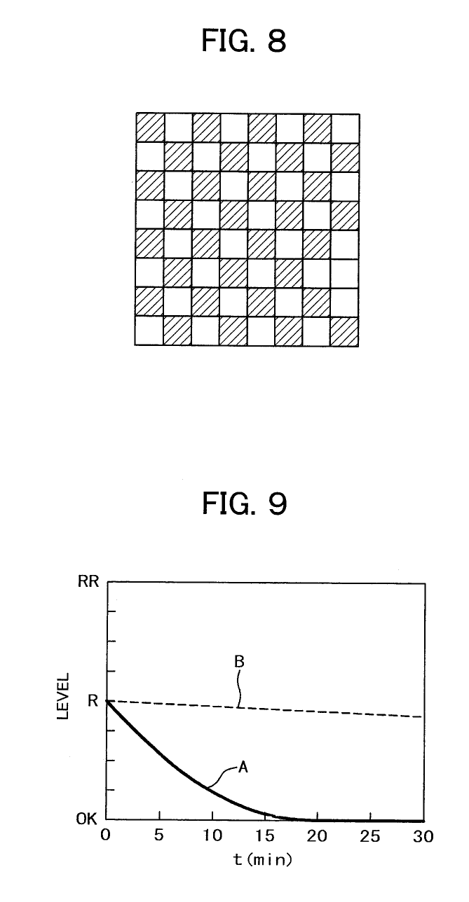

FIG. 7 shows the effect of the constitution described above on second image sticking. In FIG. 7, evaluation was performed for samples by the number of 13 whose parameters are changed. In the table of FIG. 7, low resistance ingredient materials are materials formed of the polyamide acid as the precursor that constitute the lower alignment film. For the low resistance material ingredients formed of the polyamide acid as the precursor, the effect is compared between cases where the polyamide acid is formed of PMDA as the starting material or not and between cases where the polyamide acid contains the sulfonic acid group or the carboxylic group or not.

In the optical alignment, it is necessary to irradiate an alignment film with UV-light and apply heating to the alignment film. The step includes performing UV light irradiation and heating simultaneously to the alignment film (simultaneous heating in FIG. 7) and irradiating the alignment film with UV light and then heating the film (subsequent heating in FIG. 7). Further, alignment films for evaluation are formed while the heating temperature is changed as 180° C., 200° C., and 230° C. For liquid crystals, identical liquid crystals are used in each of the cases. As the interlayer insulating film, comparison is made between films having a thickness of 500 nm as in the existent example and films having a larger thickness of 770 nm.

For the samples prepared by the number of 13 as described above, the DC brightness moderation time constant shown in FIG. 5 is compared between the DC brightness moderation time constant T1 upon light irradiation at a brightness of 1000 cd/m² and a DC brightness moderation time constant T2 upon light irradiation at a brightness of 10,000 cd/m². Table 7 also shows T1/T2 values. Then, presence or absence of the second image sticking is evaluated for each of the samples.

FIG. 7 shows a state where the second image sticking is generated as “X” and a state where the second image sticking is not generated as “◯”. As shown in FIG. 7, when a polyamide acid as the precursor formed of PMDA as the starting material is used for the lower alignment film (low resistance ingredient material), the second image sticking is generated in all of the samples. Further, even when the polyamide acid formed of PMDA as the starting material is not used as the precursor for the alignment film (low resistance ingredient material), second image sticking is generated if the sulfonic acid group or the carboxylic acid group is not present and when the thickness of the interlayer insulating film is 500 nm as in the existent case.

On the contrary, second image sticking is not generated in all of samples Nos. 9, 10, 11, and 13 where the polyamide acid as the precursor formed of PMDA as the starting material is not used and the sulfonic acid group or the carboxylic acid group is present. Further, even when the polyamide acid as the precursor formed of PMDA as the starting material is not used and neither the sulfonic acid group nor the carboxylic acid group is present, second image sticking is not generated if the thickness of the interlayer insulating film is 770 nm.

Further, no significant difference is observed for the second DC image sticking depending on the process of optical alignment, that is, whether the polarized UV light is irradiated or not before heating, or heating temperature, etc.

As has been described above, when the polyamide acid as the precursor formed of PMDA as the starting material is not used and the polyamide acid containing the sulfonic acid group or the carboxyl group is used for the lower alignment film (low resistance ingredient material), second image sticking is not generated in all of the cases. On the other hand, even when the polyamide acid as a precursor formed of PMDA as the starting material is not used, and the polyamide acid containing neither the sulfonic acid group nor the carboxylic group is used for the lower alignment film (low resistance ingredient material), the second image sticking is not generated if the thickness of the interlayer insulating film is 770 nm.

What is claimed is:

1. A liquid crystal display device comprising:
a TFT substrate having an alignment film formed over pixels each having a pixel electrode and a TFT;
a counter substrate opposed to the TFT substrate, the counter substrate having another alignment film formed over a color filter, and;
liquid crystals put between the alignment film of the TFT substrate and the alignment film of the counter substrate;
wherein
the alignment film comprises a first alignment film in contact with a liquid crystal layer and a second alignment film formed below the first alignment film,
the first alignment film is formed of a polyamide acid ester as a precursor, and
the second alignment film is formed of a polyamide acid, as a precursor, that contains a sulfonic acid group or a carboxylic group, without the use of PMDA as a starting material.

2. A liquid crystal display device comprising:
thin film transistors;
a TFT substrate having an alignment film formed over pixels where pixel electrodes are formed over a common electrode by way of an interlayer insulating film;
a counter substrate opposed to the TFT substrate, the counter substrate having another alignment film formed over a color filter; and
liquid crystals put between the alignment film of the TFT substrate and the alignment film of the counter substrate;
wherein
the alignment film comprises a first alignment film in contact with a liquid crystal layer and a second alignment film formed below the first alignment film,
the first alignment film is formed of a polyamide acid ester as a precursor, and
the second alignment film is formed of a polyamide acid, as a precursor, for which PMDA is not used as a starting material, with the thickness of the interlayer insulating film being 770 nm or more.

3. A liquid crystal display device comprising:
thin film transistors;
a TFT substrate having an alignment film formed over pixels where pixel electrodes are formed over a common electrode by way of an interlayer insulating film;
a counter substrate opposed to the TFT substrate, the counter substrate having another alignment film formed over a color filter; and
liquid crystals put between the alignment film of the TFT substrate and the alignment film of the counter substrate;
wherein the alignment film comprises a first alignment film in contact with a liquid crystal layer and a second alignment film formed below the first alignment film, and
wherein, when a DC voltage is applied between the counter substrate and the pixel electrode while light is irradiated at the back of the liquid crystal display device,
the following ratio T1/T2 is defined as 3 or less,
assuming the brightness just after the application of the DC voltage as B1, and the brightness when the brightness is subsequently settled as B2, and
assuming a time when the brightness settles from the initial brightness B1 to a brightness: B2+(B1−B2)×0.368 as T, where
T is T1 for the brightness of light at I, and
T is T2 for the brightness of light at I×10.

4. A liquid crystal display device according to claim 3, wherein T1 is 30 minutes or less when the brightness I is set at 1,000 cd/m².

5. A liquid crystal display device according to claim 1, wherein the liquid crystal has a pre-tilt angle of 0 degree.

6. A liquid crystal display device according to claim 2, wherein the liquid crystal has a pre-tilt angle of 0 degree.

7. A liquid crystal display device according to claim 3, wherein the liquid crystal has a pre-tilt angle of 0 degree.

8. A liquid crystal display device according to claim 4, wherein the liquid crystal has a pre-tilt angle of 0 degree.
